(19) United States
(12) Patent Application Publication
(10) Pub. No.: US 2026/0016195 A1
(43) Pub. Date: Jan. 15, 2026

(54) CONCENTRATED SOLAR POWER SYSTEM FOR GENERATING ELECTRICTY AND METHOD OF FORMING THE SAME

(71) Applicant: Holtec International, Camden, NJ (US)

(72) Inventor: Krishna P. SINGH, Jupiter, FL (US)

(73) Assignee: Holtec International, Camden, NJ (US)

(21) Appl. No.: 19/257,123

(22) Filed: Jul. 1, 2025

Related U.S. Application Data
(60) Provisional application No. 63/670,371, filed on Jul. 12, 2024.
(60) Provisional application No. 63/671,445, filed on Jul. 15, 2024.
(60) Provisional application No. 63/697,991, filed on Sep. 23, 2024.

(51) Int. Cl. F24S 20/20; F24S 10/70; F24S 23/70

(52) U.S. Cl. CPC F24S 20/20; F24S 10/72; F24S 23/70; F24S 2020/23

(57) ABSTRACT

A method of forming a concentrated solar power system for generating electricity. The method has three steps. The first step is coupling a plurality of tower segments together onsite at a solar energy concentration field to form a solar tower in a lowered orientation. At least one solar receiver is coupled to the solar tower to form a solar tower assembly. The second step is raising the solar tower assembly to a solar energy collection orientation by pivoting the solar tower assembly about a pivot axis located at a bottom portion of the solar tower. The third step is securing the solar tower assembly in the solar energy collection orientation.

### CROSS-REFERENCE TO RELATED APPLICATIONS

The present application claims the benefit of U.S. Provisional Patent Application Ser. No. 63/670,371 filed Jul. 12, 2024, U.S. Provisional Patent Application Ser. No. 63/671,445 filed Jul. 15, 2024, and U.S. Provisional Patent Application Ser. No. 63/697,991 filed Sep. 23, 2024, the entireties of which are hereby incorporated by reference herein.

### FIELD OF THE INVENTION

The present invention relates to concentrated solar power generation systems for producing electric power, and methods of forming said concentrated solar power generation systems.

### BACKGROUND OF THE INVENTION

Thermal energy reaching earth from the sun is quite immense. Yet, harnessing it for useful purposes has been difficult. For over 200 years, fossil fuels excavated from the ground have been the mainstay for energy supply needed to support human civilization. Solar energy, although ubiquitous and visibly strong between the equatorial and subtropical regions of the earth (between the lines of Cancer and Capricorn), drew little attention until the late 20^{th} century when the nexus between the carbon spewed into the environment by burning of fossil fuels and global climate disruption became impossible to ignore. Solar energy generation, long an object of scant scientific work, now has been vaulted into a central area of academic and industrial research.

Improvements in renewable solar power generation systems are desired which can reduce reliance on fossil fuels while simultaneously decreasing greenhouse gas emission which contributes to global climate change. Further, these solar power generation systems are desired to be optimized to significantly reduce the installed cost of these thermal energy systems while also increasing their structural capacity to withstand extreme environmental loadings such as earthquakes, hurricanes, tornadoes, and the like.

### SUMMARY OF THE INVENTION

In one aspect, the invention can be a concentrated solar power system for generating electricity. The system comprises a heliostat field configured to concentrate solar energy, a solar tower assembly comprising a hollow cylindrical solar tower, and at least one solar receiver mounted to the hollow cylindrical solar tower. The at least one solar receiver positioned to receive concentrated solar energy from the heliostat field.

In another aspect, the invention may be a method of forming a concentrated solar power system for generating electricity. The method comprising three steps. The first step comprises coupling a plurality of tower segments together onsite at a solar energy concentration field to form a solar tower in a lowered orientation. In the first step, at least one solar receiver is coupled to the solar tower to form a solar tower assembly. The second step comprises raising the solar tower assembly to a solar energy collection orientation by pivoting the solar tower assembly about a pivot axis located at a bottom portion of the solar tower. The third step comprises securing the solar tower assembly in the solar energy collection orientation.

In another aspect, the invention may be an alternative method of forming a concentrated solar power system for generating electricity, the method comprising three steps. The first step comprises coupling a plurality of tower segments together onsite at a solar energy concentration field to form a solar tower in a substantially horizontal orientation. The solar tower is configured to have at least one solar receive mounted thereto. The second step comprises raising the solar tower to a solar energy collection orientation in which the at least one solar receiver. When mounted to the solar tower, the solar receiver will be positioned to receive concentrated solar energy from a heliostat field. The third step comprises securing the solar tower in the solar energy collection orientation.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The features of the exemplary embodiments of the present invention will be described with reference to the following drawings, where like elements are labeled similarly, and in which:

FIG. 1 is an elevated plan view of a concentrated solar power system for generating electricity;

FIG. 2 is a schematic view of the system of FIG. 1;

FIG. 3 is an isometric view of a solar power tower assembly;

FIG. 4 is an exploded assembly view of the solar power tower assembly of FIG. 3;

FIG. 5 is an isometric view of a lower portion of the solar power tower assembly of FIG. 3;

FIG. 6A is an isometric view of an inner shell of the solar power tower assembly of FIG. 3;

FIG. 6B is an isometric view of an outer shell of the solar power assembly of FIG. 3;

FIG. 7 is a front view of the inner shell of FIG. 6A;

FIG. 8 is a partial cross-sectional view of the inner shell of FIG. 6A and the outer shell of FIG. 6B;

FIG. 9A is side-view of the solar power tower assembly of FIG. 3 in a lowered position;

FIG. 9B is a side-view of the solar power tower assembly of FIG. 3 being pivoted about a pivot axis;

FIG. 10a is a side-view of the lower portion of the solar power tower assembly of FIG. 5 being pivoted about a pivot axis;

FIG. 10b is a side-view of the lower portion of the solar power tower assembly of FIG. 5 in an unlocked position;

FIG. 10c is a side-view of the lower portion of the solar power tower assembly of FIG. 5 in a locked position;

FIG. 11 is an isometric view of a solar receiver for the solar power tower assembly of FIG. 3

FIG. 12 is an exploded assembly view of the solar receiver of FIG. 12; and

FIG. 13 is top view of an arrangement of heat exchangers for the solar receiver of FIG. 12.

All drawings are schematic and not necessarily to scale. Parts given a reference numerical designation in one figure may be considered to be the same parts where they appear in other figures without a numerical designation for brevity unless specifically labeled with a different part number and described herein. Any reference herein to a whole figure number herein which may comprise multiple figures with the same whole number but different alphabetical suffixes shall be construed to be a general reference to all those figures sharing the same whole number, unless otherwise indicated.

### DETAILED DESCRIPTION OF THE EMBODIMENTS

The features and benefits of the invention are illustrated and described herein by reference to exemplary (“example”) embodiments. This description of exemplary embodiments is intended to be read in connection with the accompanying drawings, which are to be considered part of the entire written description. Accordingly, the disclosure expressly should not be limited to such exemplary embodiments illustrating some possible non-limiting combination of features that may exist alone or in other combinations of features.

In the description of embodiments disclosed herein, any reference to direction or orientation is merely intended for convenience of description and is not intended in any way to limit the scope of the present invention. Relative terms such as “lower,” “upper,” “horizontal,” “vertical,”, “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise.

As used throughout, any ranges disclosed herein are used as shorthand for describing each and every value that is within the range. Any value within the range can be selected as the terminus of the range. In addition, all references cited herein to prior patents or patent applications are hereby incorporated by reference in their entireties. In the event of a conflict in a definition in the present disclosure and that of a cited reference, the present disclosure controls.

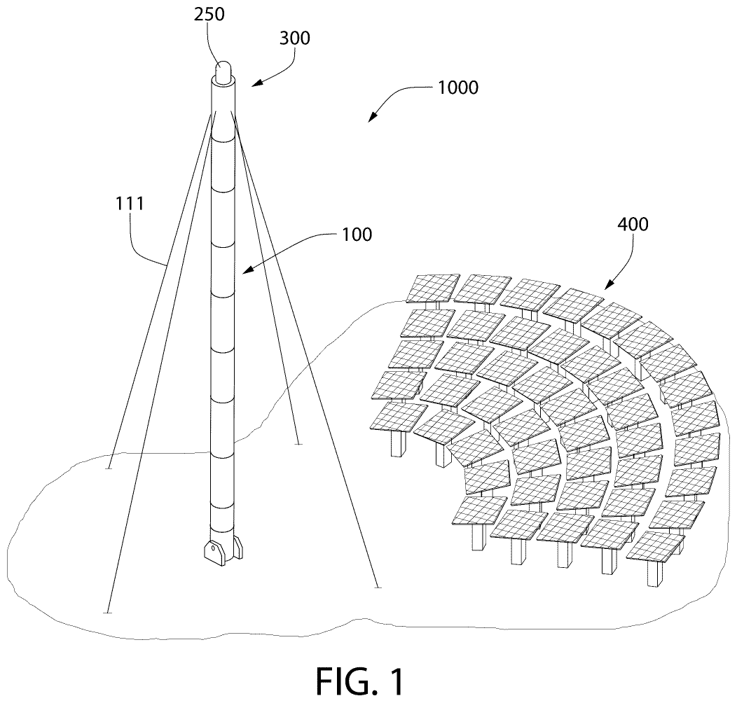

Referring first to FIG. 1, a concentrated solar power system 1000 for generating electricity is shown. The concentrated solar power system 1000 comprises a heliostat field 400 configured to concentrate solar energy by reflecting incoming solar radiation and a solar tower assembly 300 that receives the reflected solar radiation. The solar tower assembly 300 may comprise a solar tower 100 and at least one solar receiver 200 mounted to the solar tower 200. Anchored guy wires 111 may be attached to the tower 100 and tensioned to add stability, but the solar tower 100 is otherwise free standing. The structural details of both the hollow cylindrical solar tower 100 and the solar receiver 200 will be discussed in further detail below.

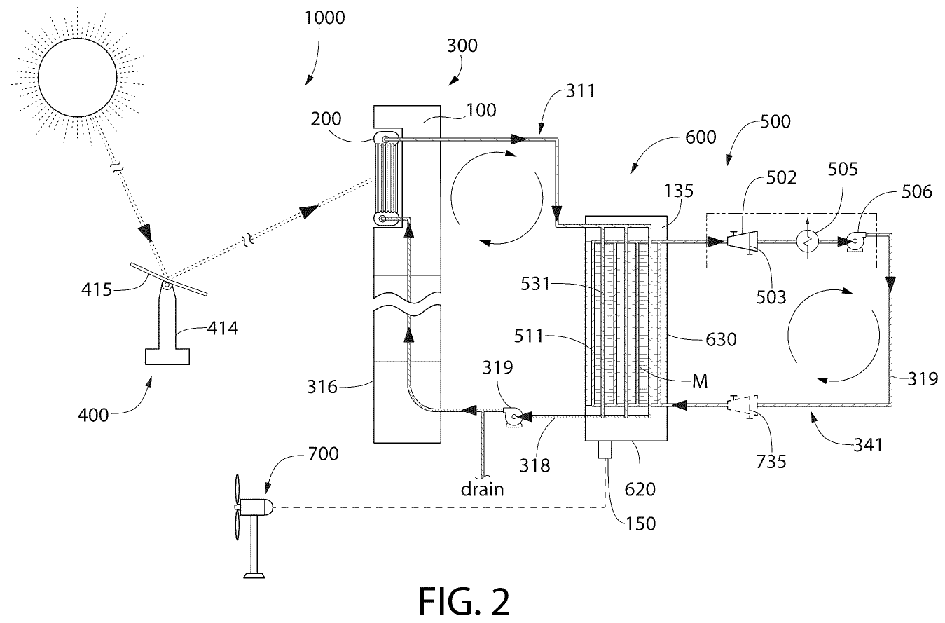

Referring to FIG. 2, a schematic system flow diagram showing the concentrated solar power generation system 1000 according to one embodiment of the present disclosure. The system in part may include a Rankine steam power cycle which derives input energy from solar thermal energy capture in lieu of fossil fuels to generate the steam necessary to produce electricity.

The concentrated solar power generation system 1000 in one embodiment generally includes the heliostat array 400, the solar tower assembly 300, a power generation system 500 comprising a steam turbine 541 and electric generator 542, and thermal energy storage system 600 which operably and thermally couples the systems 300 and 500 together. Systems 300 and 500 however are fluidly isolated from each other. As further described herein, the intermediary thermal energy storage system 600 comprises “green boiler” 620, which in one embodiment may be formed by a vessel 630 containing a thermal mass composition M specially configured and operable to absorb heat energy and yield the heat energy on demand to produce steam for driving the power generation system 500.

The solar tower assembly 300 is configured to circulate the first heat transfer working fluid (“first working fluid” for short) in a first closed flow loop 311 between the solar tower assembly 300 and the vessel 630 where the captured solar heat or thermal energy from the collector is used to heat to thermal mass composition M contained in the vessel 630. Flow conduits 318 form integral external portions of the first flow loop 311 to circulate the first working fluid between the solar tower assembly 300 and the vessel 630. In one embodiment, the flow conduits 318 may be formed by piping made of a material suitable for handling the temperatures, pressures, and chemistry of the first working fluid. The flow conduits may be insulated and, if necessary, heat traced in some embodiments to minimize heat loss from the first working fluid. The first closed flow loop 311 includes at least one recirculation pump 319 which provides the motive force to recirculate the first working fluid through the first closed flow loop. Pump 319 may be located in first closed flow loop 311 upstream of the solar tower assembly 300 but downstream of the vessel 630 as shown in FIG. 2.

The first working fluid may be molten salt or heat transfer oil in some embodiments as previously described herein. Other suitable heat transfer working fluids however may be used if appropriate.

The thermal energy storage system 600 includes green boiler 620 previously described herein which comprises heavily insulated TES vessel 130. The vessel 630 includes and contains first and second pluralities of fluidly isolated boiler heat exchange tubes that form heat exchangers which are integral parts of the vessel. The first plurality of boiler heat exchange tubes 331 are integral fluidic parts of the first closed flow loop 311 associated with the solar tower assembly 300. The second plurality of boiler heat exchange tubes 511 are integral fluid parts of the second closed flow loop 341 associated with the power generation system 500.

The TES vessel 630 in some embodiments may optionally be equipped with supplementary heat input capability in the form of electric immersion heaters 650 that can extract electric power from the grid to heat the thermal mass composition M preferably when the power is cheap, such as during off-peak load demand operating periods of the electric power grid. However, if supplemental heat is needed to heat the thermal mass composition to operating temperatures at other times, the heaters could be energized during peak or normal operating periods of the electric power grid in order for the solar power generation system to continue generating power. Alternatively, the electric power source for the electric immersion heaters 650 may be a wind farm comprising one or more wind turbine-generators 700 which are electrically coupled to the heaters.

The power generation system 500 of the concentrated solar power generation system 1000 may a steam power generation system generally including without limitation a conventional steam turbine-generator set including steam turbine 502, electric generator 503 mechanically coupled thereto and operably connected to the electric power grid, steam condenser 505 which condenses the steam into condensate, and boiler feedwater pump 506. These components (excluding the generator of course) form integral fluidic parts of the second closed flow loop 341 along with the heat exchange portion of the green boiler 620 (TES vessel 130) which conveys the second working fluid therethrough to absorb heat from the thermal mass composition M to produce steam which runs the steam turbine-generator set to generate electricity. The generator produces electricity in a conventional manner via a stator and rotor assembly well known in the art. The feedwater pump 506 circulates the boiler feedwater through the second closed flow loop 341 formed in part by flow conduits 319 such as piping which fluidly couples the water bearing components of the Rankine cycle and TES vessel together as shown. With exception of the present green boiler 620, the remaining balance of plant components of the clean energy Rankine cycle necessary to form a complete power generation system may be provided and operate in the same foregoing and well-known manner as traditional Rankine cycle components to produce electricity.

The heliostat array may be a circular array of heliostats 413 that encircle the centrally-located solar tower assembly 300 (only one heliostat being shown in FIG. 2 for sake of brevity). Heliostats 413 are commercially available in a wide range of sizes and curvatures from multiple suppliers. The solar tower assembly 300 receives thermal energy delivered to it by the heliostats 413. The heliostats 413 each generally include a support frame 414 typically mounted on the ground (or another available support surface) and an adjustable reflector 415 configured to capture and reflect incident solar radiation or light. The adjustable reflectors 415 in one embodiment may each be formed by a concave mirror with radius of curvature set to focus solar energy incident on its surface onto at least one solar receiver 200 mounted on an upper portion of the hollow cylindrical solar tower 100. The sun's radiant energy (heat) is collected by the concave mirrors mounted on a drive mechanism that enables the mirrors to index and continuously face towards the sun as it traverses the sky through the day to optimize the amount of solar radiation captured.

The solar receiver 200 may be positioned at multiple elevations in a sufficiently tall cylindrical solar tower 100 so that radiant heat energy of the sun can be more effectively captured from a large heliostat field. The solar receiver 200 is integrated fluidically with parts of the first closed loop 311 which serve to convey the received thermal energy from the sun to the TES vessel 630 which in turn is interfaces with the power generation system 500. The receivers 317 are heat exchangers with heat exchange tubes as further described herein which serve as the entry point for the thermal energy input into the solar energy collection system, which heats the recirculating first working fluid to a desired target temperature. The structural details of the solar receiver 200 will be discussed in further detail below.

According to another aspect of the invention, the hybrid power generation system may be used to operate a Brayton power generation cycle using a suitable compressible gas such as air, carbon dioxide (CO2), or other. Supercritical CO2 may be used in some embodiments. The gas is the second working fluid for the power generation system portion of the hybrid system. The gas is heated by the thermal mass composition M heated by solar or wind energy which increases the enthalpy of the gas. The gas then flows through a turbine-generator set similar to turbine-generator set 502, but operated via compressed gas in lieu of steam. The Brayton system can be visualized in FIG. 2 by insertion of a gas compressor 735 (represented schematically by dash lines) in the second closed flow loop 341 between the steam turbine 502 and inlet to TES vessel 630. Steam condenser 505 and feedwater pump 506 associated with the Rankine cycle are of course omitted. Brayton power generation cycle systems and equipment are well known in the art. It is well within the ambit of those skilled in the art to form a hybrid power generation system using the Brayton gas power generation cycle in lieu of the Rankine steam power generation cycle based on the information provided in the present disclosure.

The concentrated solar power system 1000 disclosed herein may utilize an optimization algorithm that maximizes the total solar exposure to the array of heliostats on a given land area. This optimization formalism considers the plot size and latitude of the plant's location. The Heliostats' size and their spacing are available parameters that can be varied to arrive at the highest solar energy capture configuration. Calculations show that in the region between the line of Capricorn and the line of Cancer, daily Energy Capture Density (ECD) as high as 5 MWh per acre of heliostat-seeded land can be achieved. In more temperate regions of the earth, the ECD may be somewhat less, down to ˜4MWh per acre.

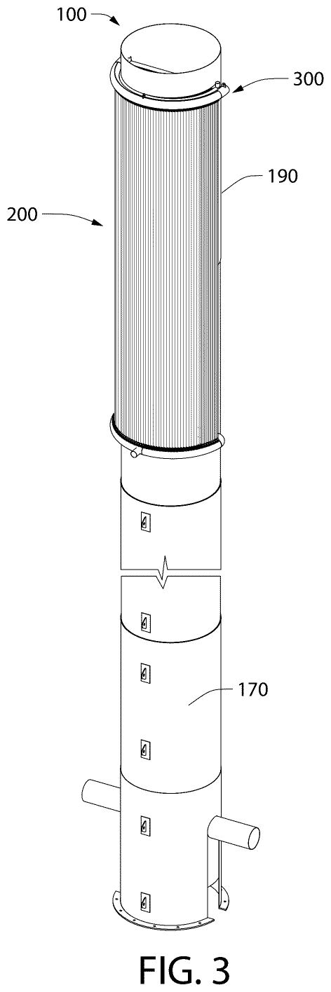

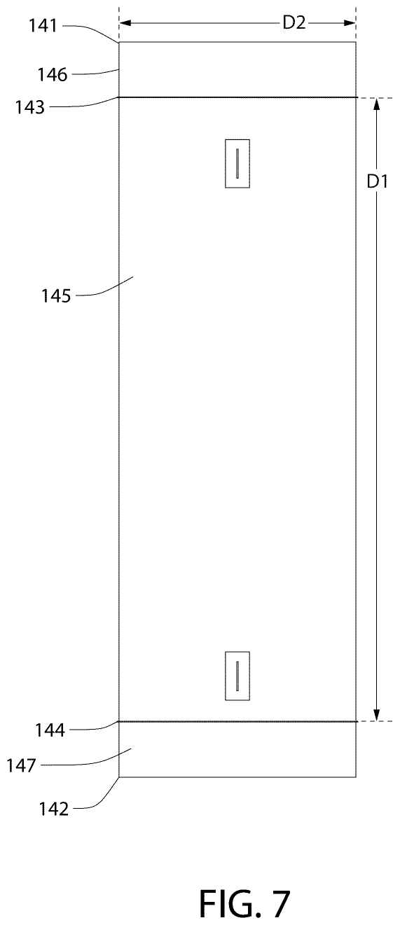

Referring to FIGS. 3-9, the individual components of the solar tower assembly 300 are shown in greater detail. The solar tower 100 of the solar tower assembly 300 may be fabricated from a plurality of hollow tower segments 150 such that the solar tower as a whole forms a hollow cylinder. Thus, the solar tower 100 has a modular construction and can be manufactured in separate segments. In the exemplified embodiment, the solar tower 100 is approximately 330 ft tall (approximately 100 m) in total height as measured from the ground. However, as the solar tower 100 is made up of a plurality of individual tower segments 150, the ultimate height of the tower may vary. For instance, the solar tower height may range from 160 ft (approximately 49 m) tall to 800 ft (approximately 244 m). The exact height of the solar tower 100 is not bound to this exact range and may be varied according to manufacturing the heliostat array 400 arrangement. Further, the hollow structure can be used to install ancillary hardware such as ladders, platforms, a crew elevator, and air circulators.

Because the solar tower 100 is virtually entirely shop manufactured and the site construction, the installed cost may be significantly lower than traditional truss solar towers. The cost will experience additional significant reduction if the tower and its parts are manufactured in a continuous production mode rather than the custom fabrication format which has been the practice in the industry thus far. Further, the use of robots and other forms of automation to make site welds will further reduce the extent of required human labor and duration of work, thereby reducing costs further.

In the exemplified embodiment, the plurality of tower segments 150 are formed by a plurality of cylindrical shells 151. Such a design provides a sheltered space where piping, valves, control panels as well as elevators can be housed. Further, a cylindrical steel structure is far more readily adapted for periodic application of preservatives compared to truss-like towers. The plurality of cylindrical shells 151 comprise inner shells 140 and outer shells 160. In the exemplified embodiment, the inner shells 140 and the outer shells 160 are made of carbon steel with suitable surface protectant applied to prevent corrosion. In some embodiments, stainless steel may be used. However, any metallic material with sufficient corrosion resistant and mechanical properties may be utilized. Further, each of the inner shells 140 and outer shells comprise a guy wire attachment point 152 configured for a guy wire 111 to be attached.

In the exemplified embodiment, each of the inner shells 140 and outer shells 160 are manufactured to the same overall length. This overall length may be 40 ft (approximately 12 m). The inner shells 140 are manufactured to have an outer diameter DI that is slightly smaller than the inner diameter D2 of the outer shells 160 so allow for the outer shells 160. This allows the inner shells 140 to slide into the outer shells 160 during construction. Further, at least a section of the solar tower 100 is formed by an alternating arrangement of the inner shells 140 and outer shells 160. The exact dimensions of outer diameter DI of each of the inner shells 140 and the inner diameter D2 of each of the outer shells 160 are governed by limitations in shipping logistics. However, in the exemplified embodiment, the outer diameter D1 of each of the inner shells is 13 ft. (approximately 3.96 m) and the inner diameter D2 of each of the outer shells 160 is 13 ft, 1 in. (approximately 3.99 m).

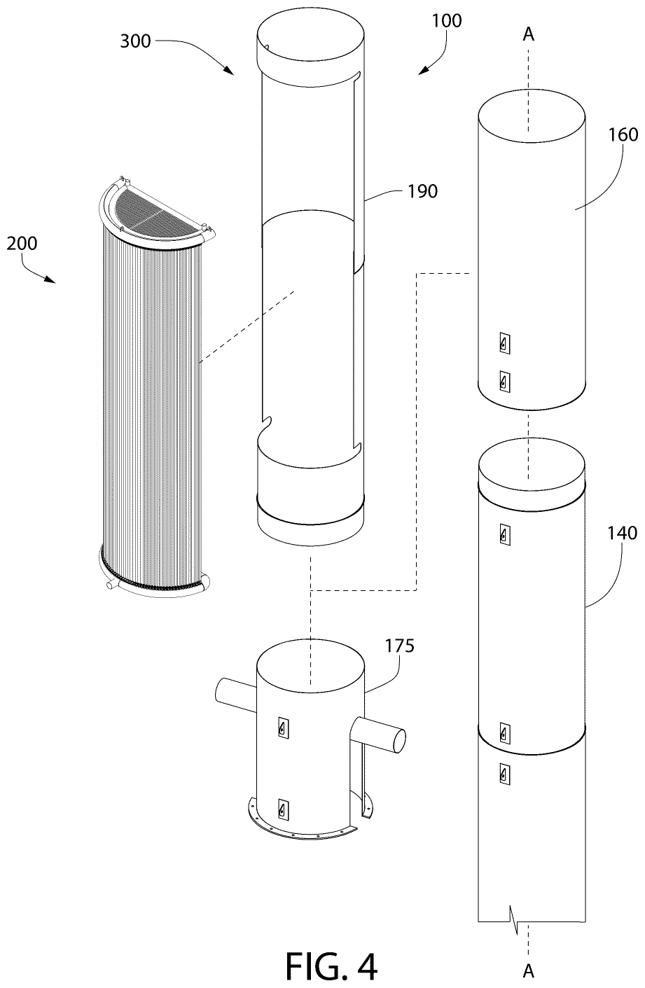

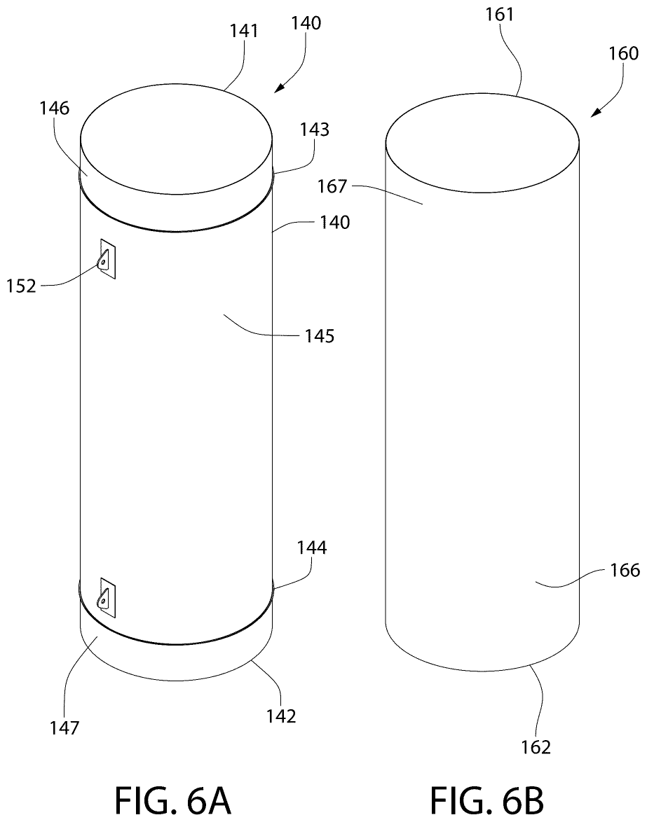

Referring specifically to FIGS. 4, and 6A-B, each of the inner shells 140 extends along a shell axis A-A from a first end 141 to a second end 142. Each of the outer shells 160 also extend along the shell axis A-A from a first end 161 to a second end 162. Thus, the inner shells 140 and outer shells 160 are co-axial when the solar tower 100 is assembled. In the exemplified embodiment, each of the inner shells 140 comprises first mechanical interference component 143 and a second mechanical interference component 144 protruding from an outer surface 145 of the inner shell 140. Both the first mechanical interference component 143 and the second mechanical interference component 144 may be narrow, circumferential rings that serve to prevent sliding between the inner shells 140 and the outer shells 160 when the solar tower 100 is assembled. The first mechanical interference component 143 and the second mechanical interference component 144 may be axially space apart by a distance D1 that is more than 50% of a length D3 of the inner shell 140.

Each of the inner shells 140 comprises a first end portion 146 that is defined between the first end 141 and the first mechanical interference component 143 and a second end portion 147 that is defined between the second end 142 and the second mechanical interference 144 component. The first end portion 146 and the second end portion 147 form a portion of the outer surface 145 of the inner shell.

In the exemplified embodiment, each of the first mechanical interference components 143 and second mechanical interference components 144 may further comprise an annular flange 148 protruding from the outer surface of the inner shell 145. The annular flange 148 extends from the outer surface of the inner shell 140 far enough so that the outer diameter of the inner shell 140 is greater at the first mechanical interference component 143 and second mechanical interference component 144 than an outer diameter of each of the outer shells 160. The annular flange 148 may be welded onto the outer surface 145 or it may be integrally formed from the inner shell 140. In other embodiments, the first mechanical interference components 143 and second mechanical interference components 144 may not comprise an annular flange 148 at all, and instead have integrally formed bumps, grooves, slots, or other such structure that serves to stop the sliding between the inner shells 140 and the outer shells 160.

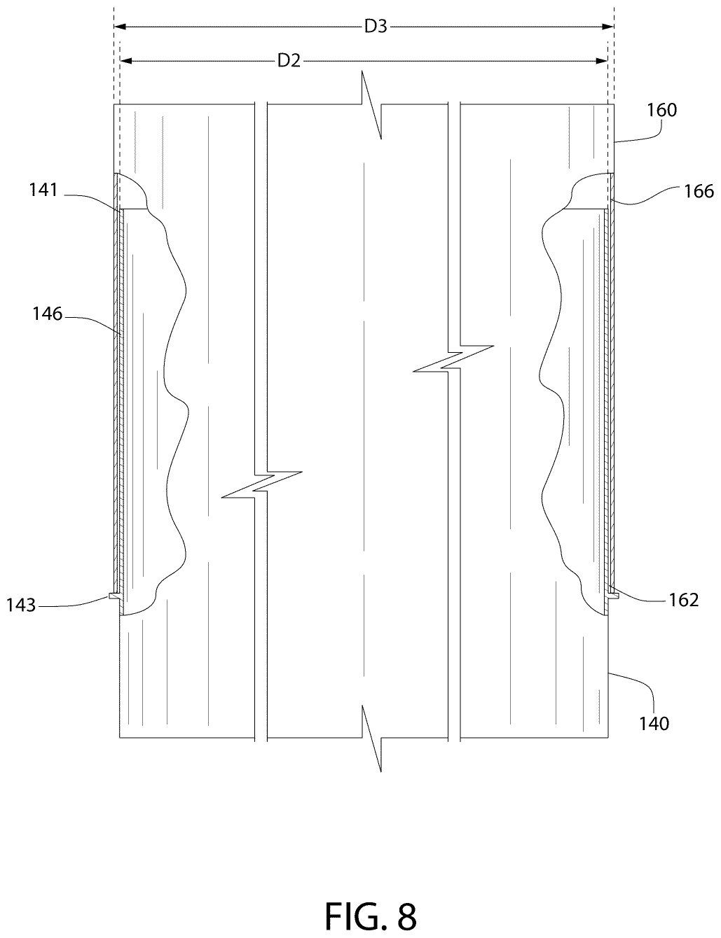

Referring specifically now to FIG. 8, in the exemplified embodiment when the plurality of cylindrical shells 151 are assembled, the first end portion 146 of each of the inner shells 140 nests within a second end portion 167 of a first one of the outer shells 160. This results in the second end 162 of the first one of the outer shells 160 abutting the first mechanical interference component 143 of the inner shell 140. The second end portion of the inner shell nest within a first end portion of a second one of the outer shells and the first end of the second one of the outer shells abuts the second mechanical interference component of the inner shell. Circumferential welds are used to join the inner shells 140 with the first one of the outer shells 160 together.

Referring specifically to FIGS. 4-5 and 10A-C, the solar tower assembly further comprises a locking collar 175 surrounds a bottom one 170 of the inner shells 140 of solar tower 100. This bottom one 170 forms a bottom portion 171 of the solar tower 100. This bottom portion 171 of the solar tower 100 is comprised of a bottom end 172 that forms the lowest portion of the solar tower 100 along the tower axis A-A when the tower is in a raised position.

The locking collar 175 further comprises a pair of elongated slots 178 through which a trunnion rod 112 extends. The trunnion rod 112 is attached to the bottom portion 171 of the solar tower 100 through a pair of through holes 179. The trunnion rod 112 extends through and protrudes from two sides of the bottom one 170 of inner shells 140. Further, the trunnions 112 are attached to anchored brackets 110 which allow the solar tower as a whole to pivot about a pivot axis from a lowered position where the tower axis A-A is substantially horizontal to a raised position where the tower axis is substantially vertical. The locking collar may be made of the same, metallic and corrosion resistant material as the inner shells 140 and the outer shells 160.

The locking collar 175 may further comprise a locking flange 176 that is configured to engage with locking members 121. The locking members 121 extend vertically from a base 115 of a pit 113. The locking flange may comprise concentrically placed through holes 174 which engage the locking members 121 when the solar tower 100 is in the vertical position. The pit 113 is a depression formed in a concrete pad 114 below the bottom end 172 of the solar tower 100. The pit 113 is designed to have sufficient depth and width to a allow the solar tower 100 to pivot about the pivot axis B-B without interference.

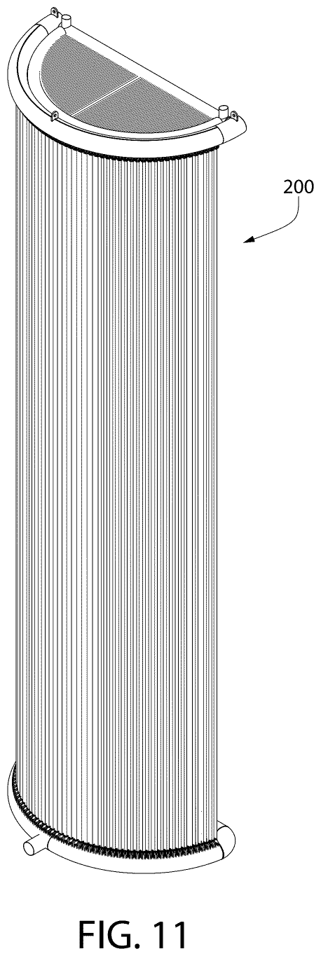

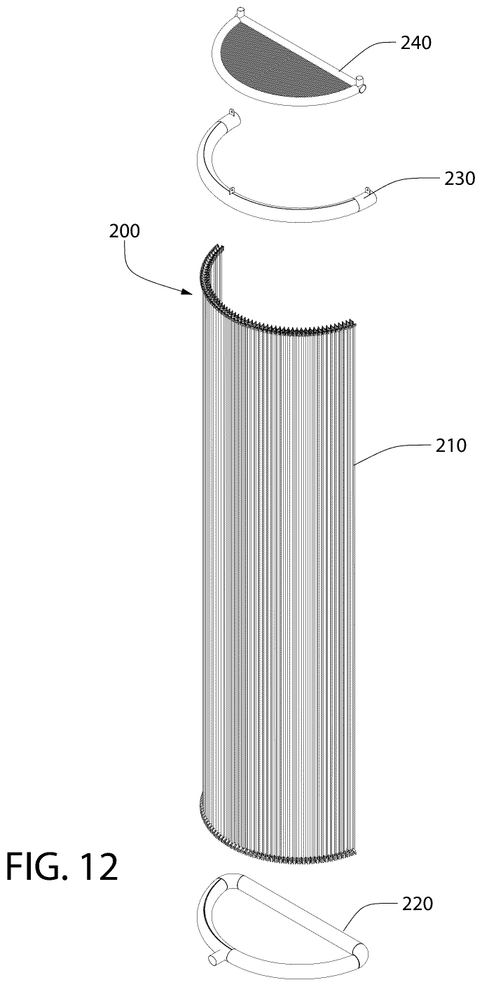

Referring specifically to FIGS. 1, and 11-13, the solar receiver 200 will be described in greater structural detail. The solar receiver 200 is a thru-tube heat exchanger with a curved circumferential profile with a radius of curvature. In some embodiments, the solar receiver 200 is conformal with the surface of the solar tower 100 such that the entire face of the Tower shell is covered. However, in other embodiments the surface of the solar receiver 200 is set back from surface of the solar tower 100. As discussed above, there may be two or more solar receivers 200 at two or more elevations mounted on the solar tower 100. The solar receivers 200 are attached to the solar tower 100 at discrete elevations that are chosen to maximize the collection efficiency of the concentrated solar power system 300.

The one solar receiver 200 comprises heat exchange tubes 210 which are coupled to an bottom header 210 and a top header 230. To protect the solar tower 100 from the “hot” tube bundle bearing molten salt in the heat exchange tubes 210, ceramic curved plates are employed along with non-organic insulation to form the mounting bracket for installing the solar receiver. The manner of connection between the receiver and its support bracket is such that the thermal expansion and contraction of the solar receiver 200 during its operation is not suppressed. In some embodiments, a metallic or ceramic “visor” is employed to block the air mass in contact with the heat exchanger tubes 210 from heating up and forming a heat extraction path by buoyancy effect. The visor also protects the solar tower 100 structure from any stray solar rays. The heat exchanger tubes 210 of the solar receiver 200 are fastened, and edge welded at their extremities to the bottom header 210 and top header 230 which are in the shape of toroidal shell segments.

In embodiments where a single solar receiver 200 is used, then it is mounted to a top portion 190 of the solar tower 100. If two or more solar receivers 200 are employed, then they are vertically spaced along the tower axis A-A to provide an optimal split of the array of heliostats 400 that would serve each solar receiver 200. Molten salt is delivered to the solar Receiver's 200 bottom header 220 and flows up the heat exchange tubes 210 reaching the top header 230 and thence an Expansion tank located above the Receiver. The unique design features built into the Receiver important to its performance are summarized in the next section.

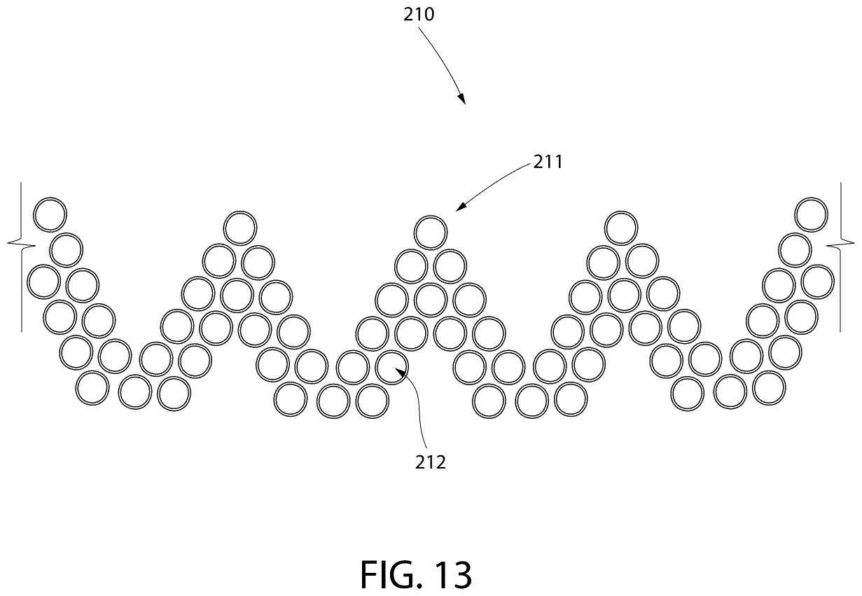

In the exemplified embodiment the heat exchanger tubes 210 of the solar receiver 200 is single tube pass (up flow; from bottom to top), where each tube has an offset and a bend in it to give it increased axial flexibility. These bends keep individual tubes from being overstressed in case the in-tube molten-salt flow or the rate of incident heat on the tubes is non-uniform. Further, as shown in particular in FIG. 13, the heat exchanger tubes 210 comprise two curvilinear rows of tubes. These curvilinear rows of tubes are divided into inner tubes 211 and outer tubes 212 which are arrayed in such a way that they form a non-pervious wall to the incoming reflected solar radiation from the heliostat array 400. This design feature eliminates the risk of the incoming hot solar beam missing the tube bundle. In fact, the tube layout is such that tubes in each row, on average, will receive nearly equal amounts of incoming solar heat. Further, the heat exchange tubes 210 may have a saw-tooth tooth profile in cross-section.

In some embodiments, the solar receiver 200 further comprises a roof tube bundle 240 that is also made of a dual row of tubes similar to the heat exchanger tubes 210. This roof tube bundle 240 can be horizontal or slightly inclined. The ends of the rows of the roof tube bundle 240 (nominally horizontal) are connected to the heat exchanger tubes 210 through the top header 230. The inside end of the nominally horizontal roof tube bundle 240 features “closure headers” that serve as the transit chamber for the molten salt stream's flow between the heat exchanger tubers 210 and the roof tube bundle 240.

The solar power tower assembly 300 may include a surge tank 250 situated above the solar receiver 200 to accommodate changes in the density of the first working fluid with temperature. The surge tank 250 may be fluidly coupled to each receiver at a suitable fluid connection point, such as the top headers 230 in one non-limiting embodiment. In other embodiments, the surge tank 250 may be connected to the roof tube bundle 240. Other suitable fluid connection locations to the receivers may be used.

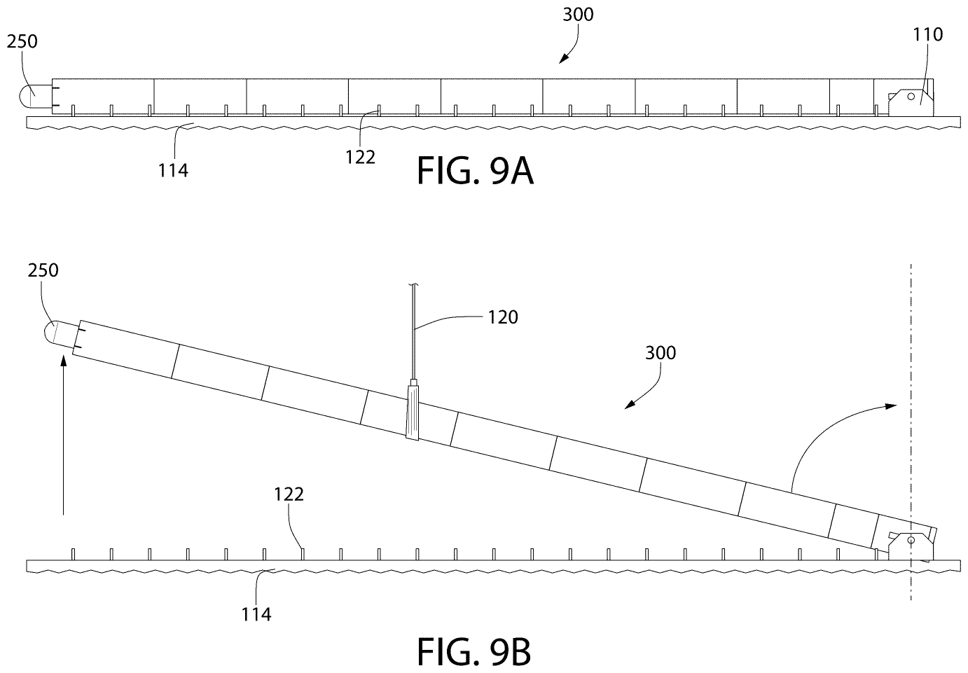

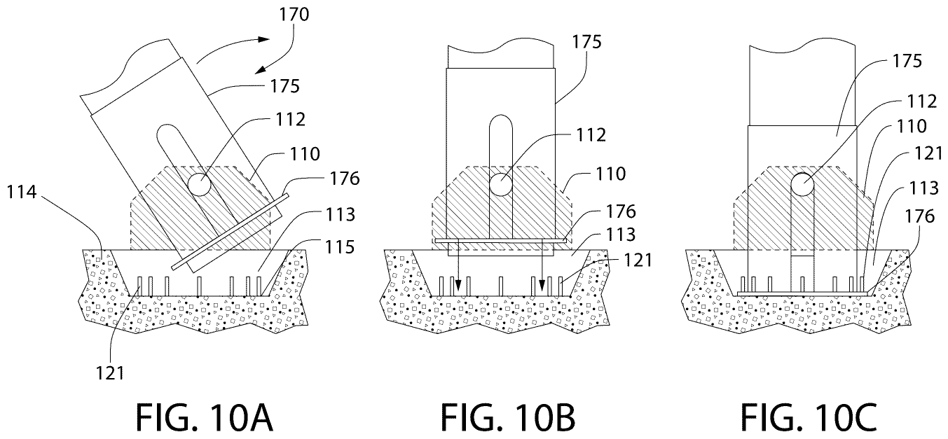

Referring to FIGS. 9A-9B and 10A-C, an example process or method for forming the concentrated solar power system 300 will be described and summarized. Before the forming process begins, the individual tower segments 150 are shop manufactured and shipped by ground transportation to the desired erection site. For example, the plurality of tower segments 150 may be received at the site in an uncombined form via railroad or truck shipping.

In the exemplified method of forming the concentrated solar system 300, the first step of the method comprises the plurality of tower segments 150 of the solar tower 100 being coupled together onsite while the solar tower 100 in the lowered orientation. In the lowered orientation, the tower axis A-A of the solar tower 100 is oriented substantially horizontal. As shown specifically, in FIG. 9A, when the solar tower 100 is in the lowered orientation, the solar tower 100 rests on a plurality ground supports 122. During this first step, at least one solar receiver 200 is coupled to the solar tower 100 to form the solar tower assembly 300. At least one solar receiver 200 is mounted in this step, though more may also be mounted. Further, the solar receiver 200 may be mounted at the top portion 190 of the solar tower 100.

In the exemplified embodiment where the plurality tower segments 150 are cylindrical shells 151, the first step further comprises slidably mating the end portions of adjacent ones of the cylindrical shells until a mechanical interference prevents further slidable mating between the adjacent ones of the cylindrical shells 151. This establishes a desired mating position for the adjacent ones of the cylindrical shells 151. After, the adjacent ones of the cylindrical shells 151 fixed together at the desired mating position to form a section of the solar tower 100.

More specifically, in embodiments where the cylindrical shells 151 are comprised of inner shells 140, and outer shells 160, the first step of the exemplified method comprises sliding the first end portion 146 of one of the inner shells 140 into a second end portion 167 of a first one of the outer shells 160 until the first mechanical interference component 143 of the one of the inner shells 140 contacts the second end 162 of the first one of the outer shells 160. This achieves the first desired mating position between the one of the inner shells 140 and the first one of the outer shells 160.

Subsequently, the one of the inner shells 140 is fixed to the first one of the outer shells 160 in the first desired mating position. This is done by circumferentially welding the one of the inner shells 140 to the first one of the outer shells 160 at the interfaces between the first mechanical interference component 143 at the second end 162 of the first one of the outer shells 160. After this first welding step, the first end portion 166 of a second one of the outer shells 160 is slid onto the second end portion 146 of the one of the inner shells 140 until the first end 161 of the second one of the outer shells 160 contacts the second mechanical interference component 144 of the one of the inner shells 140. This achieves a second desired mating position between the one of the inner shells 140 and the second one of the outer shells 160. Subsequently, the one of the inner shells 140 is fixed to the second one of the outer shells 160 in the second desired mating position by circumferentially welding the one of the inner shells 140 to the first one of the outer shells 160 at the interfaces between the second mechanical interference component 144 at the first end 161 of the second one of the outer shells 160. This method of manufacturing results in a solar tower 100 where the cylindrical shells alternate between inner shells 140 and outer shells 160. In the exemplified embodiments, all major welding when the solar tower assembly is in the lowered orientation.

Further, the first step of the exemplified method may comprise inserting the trunnion 112 into the through-hole 173 of the bottom one 170 of the plurality of tower segments 105. Next, the bottom one 170 is pivotally mounted to the pair of anchored brackets 110 to define the pivot axis B-B. The anchored brackets 110 may be secured to the concrete pad 114. The locking collar 175 is then mounted about the bottom one 170 of the plurality of tower segments 150. Further lock collar 175 is arranged such that the pair of elongated slots 178 surround the trunnion 112. In this first step, the locking collar 175 is in a raised position in which the locking collar 175 is spaced from the bottom end 172 of the bottom one 170 of the plurality of tower segments 150.

This first step may further comprise installing all the necessary piping to all of the necessary piping, valves, control panels while the solar tower 100 is in the lowered orientation. These components may be installed as individual cylindrical shells 151 are install, or they may be installed after all the cylindrical shells 151 have been attached to form the solar tower 100.

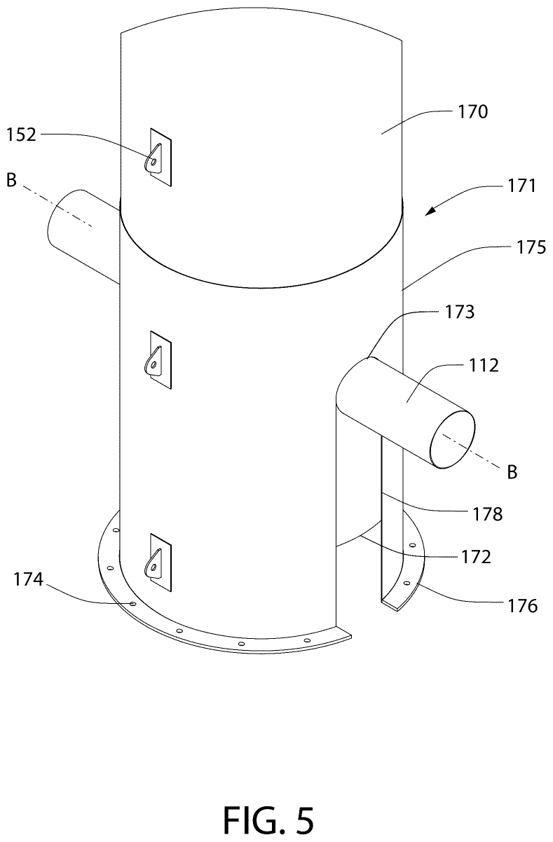

As specifically shown in FIG. 9B, the second step in the exemplary method comprises raising the solar tower assembly 300 to a solar energy collection orientation by pivoting the solar tower assembly 300 about the pivot axis B-B located at a bottom portion of the solar tower (see FIG. 5). During this step, the solar tower assembly 300 is pivoted around the trunnions 112 riding on the anchored brackets 110 using one or two crane arms 120. Further, in the solar energy collection orientation, the tower axis A-A of the solar tower 100 is oriented substantially vertical.

As shown in FIGS. 10A-10B, the third and final step of the exemplified method is securing the solar tower assembly 300 in the solar energy collection orientation. In this step, the locking collar 175 is altered from a raised positioned (FIG. 10B) to a locked position (FIG. 10C). As the locking collar 175 is mounted about the bottom one 170 of the plurality of tower segments 150, in the locking position the locking collar 175 protrudes beyond the bottom end 172 of the bottom one 170 of the plurality of tower segments 150 while at least a portion of the bottom one 170 of the plurality of tower segments 150 remains nested within the locking collar. Finally, the locking collar 175 to a base 115 when the solar tower assembly 300 is in the solar energy collection orientation. thereby preventing rotation of the solar tower assembly 300 about the pivot axis. The locking collar 175 may be secured to the base 115 by lowering the locking flange 176 onto the locking members 121. Washers, lugs, nuts or any other suitable attachment apparatuses may be threaded onto the locking members 121 to secure the solar tower assembly 300 in place. The pit 114 may optionally be filled with concrete or be left unfilled to maintain assess to the locking collar 175.

This third step of the exemplified method may further comprise connecting the anchored guy wires 111 to the solar tower assembly 300 to secure the solar tower assembly 300 in the solar energy collection orientation. Alternatively, the anchored guy wires 111 may be attached an partially tensioned in either the first step or the second step to assist in raising the solar tower assembly 300 from the lowered orientation to the solar energy collection orientation.

While the foregoing description and drawings represent exemplary embodiments of the present disclosure, it will be understood that various additions, modifications and substitutions may be made therein without departing from the spirit and scope and range of equivalents of the accompanying claims. In particular, it will be clear to those skilled in the art that the present invention may be embodied in other forms, structures, arrangements, proportions, sizes, and with other elements, materials, and components, without departing from the spirit or essential characteristics thereof. In addition, numerous variations in the methods/processes described herein may be made within the scope of the present disclosure. One skilled in the art will further appreciate that the embodiments may be used with many modifications of structure, arrangement, proportions, sizes, materials, and components and otherwise, used in the practice of the disclosure, which are particularly adapted to specific environments and operative requirements without departing from the principles described herein. The presently disclosed embodiments are therefore to be considered in all respects as illustrative and not restrictive. The appended claims should be construed broadly, to include other variants and embodiments of the disclosure, which may be made by those skilled in the art without departing from the scope and range of equivalents.

### EXEMPLARY CLAIM SET

Exemplary claim 1. A method of forming a concentrated solar power system for generating electricity, the method comprising: a) coupling a plurality of tower segments together onsite at a solar energy concentration field to form a solar tower in a lowered orientation, at least one solar receiver coupled to the solar tower to form a solar tower assembly; b) raising the solar tower assembly to a solar energy collection orientation by pivoting the solar tower assembly about a pivot axis located at a bottom portion of the solar tower; and c) securing the solar tower assembly in the solar energy collection orientation.

Exemplary claim 2. The method according to exemplary claim 1 wherein in the lowered orientation, a tower axis of the solar tower is oriented substantially horizontal.

Exemplary claim 3. The method according to any one of exemplary claims 1 to 2 wherein in the solar energy collection orientation, the tower axis of the solar tower is oriented substantially vertical.

Exemplary claim 4. The method according to any one of exemplary claims 1 to 3 wherein the plurality of solar tower sections are cylindrical shells and wherein step a) comprises: a-1) slidably mating end portions of adjacent ones of the cylindrical shells until a mechanical interference prevents further slidable mating between the adjacent ones of the cylindrical shells, thereby establishing a desired mating position for the adjacent ones of the cylindrical shells; and a-2) fixing the adjacent ones of the cylindrical shells together at the desired mating position to form a section of the solar tower.

Exemplary claim 5. The method according to exemplary claim 4 wherein step a-2) comprises welding the end portions of the adjacent ones of the cylindrical shells together.

Exemplary claim 6. The method according to any one of exemplary claims 4 to 5 wherein the cylindrical shells comprise inner shells and outer shells, each of the inner and outer shells extending along a shell axis from a first end to a second end; wherein the inner shell has an outer diameter and the outer shell has inner diameter, the sizes of the inner and outer diameters selected so that at least the end portions of the inner shell can be slid into the end portion of the outer shells.

Exemplary claim 7. The method according to exemplary claim 6 wherein step a) comprises coupling the inner and outer shells together in an alternating manner to form at least a section of the solar tower.

Exemplary claim 8. The method according to any one of exemplary claims 6 to 7 wherein each of the inner shells comprises first and second mechanical interference components protruding from an outer surface of the inner shell, the first and second mechanical interference components axially space apart by a distance that is more than 50% of a length of the inner shell, a first end portion of the inner shell being defined between the first end of the inner shell and the first mechanical interference component and a second end portion of the inner shell being defined between the second mechanical interference component and the second end of the inner shell; and wherein step a) further comprises: sliding the first end portion of one of the inner shells into a second end portion of a first one of the outer shells until the first mechanical interference component of the one of the inner shells contacts the second end of the first one of the outer shells, thereby achieving a first desired mating position between the one of the inner shells and the first one of the outer shells; fixing the one of the inner shells to the first one of the outer shells in the first desired mating position; and sliding a first end portion of a second one of the outer shells onto the second end portion of the one of the inner shells until the first end of the second one of the outer shells contacts the second mechanical interference component of the one of the inner shells, thereby achieving a second desired mating position between the one of the inner shells and the second one of the outer shells; and fixing the one of the inner shells to the second one of the outer shells in the second desired mating position.

Exemplary claim 9. The method according to claim 8 wherein each of the first and second mechanical interference component comprises an annular flange protruding from the outer surface of the inner shell.

Exemplary claim 10. The method according to any one of exemplary claims 1 to 9 further comprising: prior to step a), receiving the plurality of tower segments in uncombined form via railroad or truck shipping.

Exemplary claim 11. The method according to any one of exemplary claims 1 to 10 further comprising: wherein step a) comprises: pivotably mounting a bottom one of the plurality of tower segments to an anchored bracket to define the pivot axis, the pivot axis being fixed; and mounting a locking collar about the bottom one of the plurality of tower segments, the locking collar being in a raised position in which the locking collar is spaced from a bottom end of the bottom one of the plurality of tower segments; wherein step c) comprises: altering the locking collar from the raised position to a locking position, wherein in the locking position the locking collar protrudes beyond the bottom end of the bottom one of the plurality of tower segments while at least a portion of the bottom one of the plurality of tower segments remains nested within the locking collar; and fixing the locking collar to a base when the solar tower assembly is in the solar energy collection orientation, thereby preventing rotation of the solar tower assembly about the pivot axis.

Exemplary claim 12. The method according to exemplary claim 11 wherein step c) further comprises connecting anchored guy wires to the solar tower assembly to secure the solar tower assembly in the solar energy collection orientation.

Exemplary claim 13. The method according to any one of exemplary claims 11 to 12 wherein the locking collar comprises a pair of elongated slots through which a trunnion rod extends, the trunnion rod attached to the bottom one of the plurality of solar tower segments, the trunnion rod protruding from both sides of the bottom one of the plurality of solar tower segments and attached to the anchored bracket.

Exemplary claim 14. The method according to any one of exemplary claims 1 to 13 wherein step a) comprises mounting the at least one solar receiver to a top section of the solar tower when in the lowered orientation.

Exemplary claim 15. The method according to any one of exemplary claims 1 to 14 wherein in the solar energy collection orientation, the at least one solar receiver of the solar tower assembly is positioned to receive concentrated solar energy from a heliostat field.

Exemplary claim 16. The method according to exemplary claim 15 wherein the at least one solar receiver comprises heat exchanges tubes and is configured to receive the solar energy and conduct the solar energy through walls of the heat exchange tubes and into a heat exchange fluid flowing through the heat exchange tubes that is used, directly or indirectly, to provide thermal energy for a power cycle.

Exemplary claim 17. The method according to any one of exemplary claims 1 to 16 wherein step a) further comprises connecting piping to the at least one solar receiver when in the lowered orientation.

Exemplary claim 18. The method according to any one of exemplary claims 1 to 17 wherein step a) comprises performing all major welding when the solar tower assembly is in the lowered orientation.

Exemplary claim 19. A method of forming a concentrated solar power system for generating electricity, the method comprising: a) coupling a plurality of tower segments together onsite at a solar energy concentration field to form a solar tower in a substantially horizontal orientation, the solar tower configured to have at least one solar receive mounted thereto; b) raising the solar tower to a solar energy collection orientation in which the at least one solar receive, when mounted to the solar tower will be positioned to receive concentrated solar energy from a heliostat field; and c) securing the solar tower in the solar energy collection orientation.

Exemplary claim 20. A concentrated solar power system for generating electricity, the system comprising: a heliostat field configured to concentrate solar energy; and a solar tower assembly comprising: a hollow cylindrical solar tower; at least one solar receiver mounted to the hollow cylindrical solar tower, the at least one solar receiver positioned to receive concentrated solar energy from the heliostat field.

Exemplary claim 21. The concentrated solar power system according to exemplary claim 20 wherein at least a section of the hollow cylindrical solar tower is formed by a plurality of inner and outer shells; wherein each of the inner and outer shells extend along a shell axis from a first end to a second end; and wherein the end portions of the inner shells are nested within the end portions of the outer shells.

Exemplary claim 22. The concentrated solar power system according to exemplary claim 21 wherein the section of the hollow cylindrical solar tower is formed by an alternating arrangement of the inner and outer shells.

Exemplary claim 23. The concentrated solar power system according to any one of exemplary claims 21 to 22 wherein each of the inner shells comprises first and second mechanical interference components protruding from the outer surface of the inner shell, the first and second mechanical interference components axially space apart by a distance that is more than 50% of a length of the inner shell.

Exemplary claim 24. The concentrated solar power system according to exemplary claim 23 wherein, for each of the inner shells: (1) a first end portion of the inner shell is defined between the first end of the inner shell and the first mechanical interference component and a second end portion of the inner shell is defined between a second end of the inner shell and the second mechanical interference component; (2) the first end portion of the inner shells nests within a second end portion of a first one of the outer shells and the second end of the first one of the outer shells abuts the first mechanical interference component of the inner shell; and (3) the second end portion of the inner shell nest within a first end portion of a second one of the outer shells and the first end of the second one of the outer shells abuts the second mechanical interference component of the inner shell.

Exemplary claim 25. The concentrated solar power system according to exemplary claim 24 wherein each of the first and second mechanical interference component comprises an annular flange protruding from the outer surface of the inner shell.

Exemplary claim 26. The concentrated solar power system according to any one of exemplary claims 21 to 25 wherein the solar tower assembly further comprises a locking collar about a bottom portion of hollow cylindrical solar tower, the locking collar anchored to a base.

Exemplary claim 27. The concentrated solar power system according to exemplary claim 26 wherein the locking collar comprises a pair of elongated slots through which a trunnion rod extends, the trunnion rod attached to a bottom portion of the hollow cylindrical solar tower, the trunnion rod protruding from both sides of the bottom one of the plurality of solar tower segments and attached to an anchored bracket.

Exemplary claim 28. The concentrated solar power system according to any one of exemplary claims 21 to 27 wherein the at least one solar receiver comprises heat exchange tubes and is configured to receive the solar energy and conduct the solar energy through walls of the heat exchange tubes and into a heat exchange fluid flowing through the heat exchange tubes.

Exemplary claim 29. The concentrated solar power system according to any one of exemplary claims 21 to 27 wherein piping for the at least one solar receiver is located within a cavity of the hollow cylindrical solar tower.

1.-29. (Canceled)

30. A method of forming a concentrated solar power system for generating electricity, the method comprising:
a) coupling a plurality of tower segments together onsite at a solar energy concentration field to form a solar tower in a lowered orientation, at least one solar receiver coupled to the solar tower to form a solar tower assembly;
b) raising the solar tower assembly to a solar energy collection orientation by pivoting the solar tower assembly about a pivot axis located at a bottom portion of the solar tower; and
c) securing the solar tower assembly in the solar energy collection orientation.

31. The method according to claim 30 wherein in the lowered orientation, a tower axis of the solar tower is oriented substantially horizontal.

32. The method according to claim 30 wherein in the solar energy collection orientation, the tower axis of the solar tower is oriented substantially vertical.

33. The method according to claim 1 wherein the plurality of solar tower sections are cylindrical shells and wherein step a) comprises:
a-1) slidably mating end portions of adjacent ones of the cylindrical shells until a mechanical interference prevents further slidable mating between the adjacent ones of the cylindrical shells, thereby establishing a desired mating position for the adjacent ones of the cylindrical shells; and
a-2) fixing the adjacent ones of the cylindrical shells together at the desired mating position to form a section of the solar tower.

34. The method according to claim 33 wherein step a-2) comprises welding the end portions of the adjacent ones of the cylindrical shells together.

35. The method according to claim 33 wherein the cylindrical shells comprise inner shells and outer shells, each of the inner and outer shells extending along a shell axis from a first end to a second end; wherein the inner shell has an outer diameter and the outer shell has inner diameter, the sizes of the inner and outer diameters selected so that at least the end portions of the inner shell can be slid into the end portion of the outer shells.

36. The method according to claim 35 wherein step a) comprises coupling the inner and outer shells together in an alternating manner to form at least a section of the solar tower.

37. The method according to claim 35 wherein each of the inner shells comprises first and second mechanical interference components protruding from an outer surface of the inner shell, the first and second mechanical interference components axially space apart by a distance that is more than 50% of a length of the inner shell, a first end portion of the inner shell being defined between the first end of the inner shell and the first mechanical interference component and a second end portion of the inner shell being defined between the second mechanical interference component and the second end of the inner shell; and wherein step a) further comprises:
sliding the first end portion of one of the inner shells into a second end portion of a first one of the outer shells until the first mechanical interference component of the one of the inner shells contacts the second end of the first one of the outer shells, thereby achieving a first desired mating position between the one of the inner shells and the first one of the outer shells;
fixing the one of the inner shells to the first one of the outer shells in the first desired mating position; and
sliding a first end portion of a second one of the outer shells onto the second end portion of the one of the inner shells until the first end of the second one of the outer shells contacts the second mechanical interference component of the one of the inner shells, thereby achieving a second desired mating position between the one of the inner shells and the second one of the outer shells; and
fixing the one of the inner shells to the second one of the outer shells in the second desired mating position.

38. The method according to claim 37 wherein each of the first and second mechanical interference component comprises an annular flange protruding from the outer surface of the inner shell.

39. The method according to claim 30 further comprising:
prior to step a), receiving the plurality of tower segments in uncombined form via railroad or truck shipping.

40. The method according to claim 1 further comprising: wherein step a) comprises:
pivotably mounting a bottom one of the plurality of tower segments to an anchored bracket to define the pivot axis, the pivot axis being fixed; and
mounting a locking collar about the bottom one of the plurality of tower segments, the locking collar being in a raised position in which the locking collar is spaced from a bottom end of the bottom one of the plurality of tower segments;
wherein step c) comprises:
altering the locking collar from the raised position to a locking position, wherein in the locking position the locking collar protrudes beyond the bottom end of the bottom one of the plurality of tower segments while at least a portion of the bottom one of the plurality of tower segments remains nested within the locking collar; and
fixing the locking collar to a base when the solar tower assembly is in the solar energy collection orientation, thereby preventing rotation of the solar tower assembly about the pivot axis.

41. The method according to claim 41 wherein step c) further comprises connecting anchored guy wires to the solar tower assembly to secure the solar tower assembly in the solar energy collection orientation.

42. The method according to claim 40 wherein the locking collar comprises a pair of elongated slots through which a trunnion rod extends, the trunnion rod attached to the bottom one of the plurality of solar tower segments, the trunnion rod protruding from both sides of the bottom one of the plurality of solar tower segments and attached to the anchored bracket.

43. The method according to claim 30 wherein step a) comprises mounting the at least one solar receiver to a top section of the solar tower when in the lowered orientation.

44. The method according to claim 30 wherein in the solar energy collection orientation, the at least one solar receiver of the solar tower assembly is positioned to receive concentrated solar energy from a heliostat field.

45. The method according to claim 44 wherein the at least one solar receiver comprises heat exchanges tubes and is configured to receive the solar energy and conduct the solar energy through walls of the heat exchange tubes and into a heat exchange fluid flowing through the heat exchange tubes that is used, directly or indirectly, to provide thermal energy for a power cycle.

46. The method according to claim 30 wherein step a) further comprises connecting piping to the at least one solar receiver when in the lowered orientation.

47. The method according to claim 30 wherein step a) comprises performing all major welding when the solar tower assembly is in the lowered orientation.

48. A method of forming a concentrated solar power system for generating electricity, the method comprising:
a) coupling a plurality of tower segments together onsite at a solar energy concentration field to form a solar tower in a substantially horizontal orientation, the solar tower configured to have at least one solar receive mounted thereto;
b) raising the solar tower to a solar energy collection orientation in which the at least one solar receive, when mounted to the solar tower will be positioned to receive concentrated solar energy from a heliostat field; and
c) securing the solar tower in the solar energy collection orientation.

49. A concentrated solar power system for generating electricity, the system comprising:
a heliostat field configured to concentrate solar energy; and
a solar tower assembly comprising:
a hollow cylindrical solar tower; and
at least one solar receiver mounted to the hollow cylindrical solar tower, the at least one solar receiver positioned to receive concentrated solar energy from the heliostat field.
